(19) United States
(12) Patent Application Publication
(10) Pub. No.: US 2009/0322697 A1
(43) Pub. Date: Dec. 31, 2009

(54) TOUCH-SCREEN BASED INPUT SYSTEM AND ELECTRONIC DEVICE HAVING SAME

(75) Inventor: Shuai Cao, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (Shenzhen) CO., LTD, Shenzhen City (CN); HON HAI PRECISION INDUSTRY CO., LTD., Tu-Cheng (TW)

(21) Appl. No.: 12/488,521

(22) Filed: Jun. 20, 2009

(30) Foreign Application Priority Data
Jun. 26, 2008 (CN) 200810302356.5

(51) Int. Cl. G06F 3/041

(52) U.S. Cl. 345/173; 345/104

(57) ABSTRACT

An input system includes a first detecting unit, a second detecting unit, a reading unit, and an inputting unit. The first detecting unit is configured for detecting a first user input of performing a continuous touch operation on a location of a multi-touch screen. The second detecting unit is configured for detecting a second user input of performing a slide operation on the multi-touch screen while the first user input is detected. The reading unit is configured for reading an attribute of content at the location of the first user input if the second user input is detected. The inputting unit is configured for inputting a command corresponding to the attribute to a display driver. The command is for signaling the display driver to access data corresponding to the command and to display the accessed data on the multi-touch screen as a corresponding menu.

### BACKGROUND

1. Technical Field

The present disclosure relates to input systems and, particularly, to a touch-screen based input system and an electronic device having the same.

2. Description of Related Art

Touch screens are now widely used as inputs to electronic devices. Accordingly, many touch-screen based input systems have been proposed. For example, a proposed touch-screen based input system can present an icon on the touch-screen and, when the icon is tapped once, a corresponding access menu is displayed on the touch-screen. However, when utilizing such a touch-screen input system to trigger the menu, a user still needs to accurately tap on the icon. Otherwise, the touch-screen based input system will not response to the tap on the multi-touch screen. This is inconvenient.

Therefore, it is desirable to provide a touch-screen based input system and an electronic device having the same, which can overcome the above-mentioned problems.

### BRIEF DESCRIPTION OF THE DRAWINGS

FIG. 1 is a functional block diagram of an electronic device, according to an exemplary embodiment.

FIGS. 2-4 are views of a multi-touch screen of the electronic device of FIG. 1.

### DETAILED DESCRIPTION

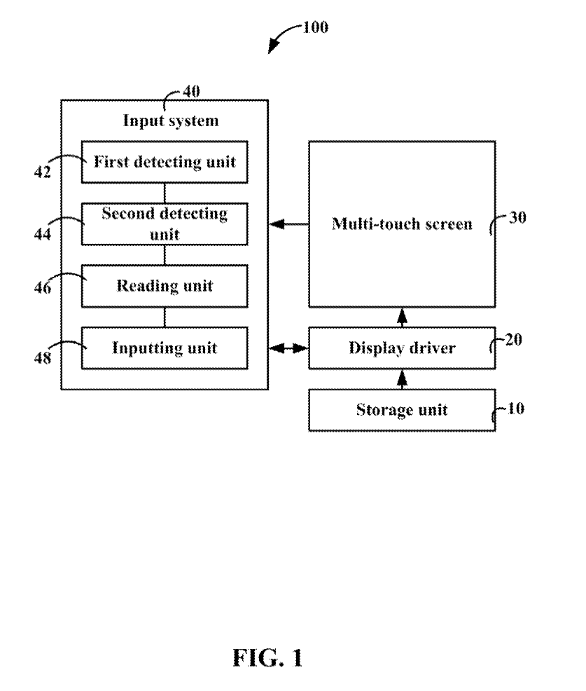

Referring to FIG. 1, an electronic device 100, such as a mobile phone, a personal digital assistant (PDA), a gaming device, or a laptop computer, according to an exemplary embodiment, is disclosed. The electronic device 100 includes a storage unit 10, a display driver 20, a multi-touch screen 30, and an input system 40.

The storage unit 10, such as a secure digital card, is configured for storing text, image, and/or hypertext information in a form of data.

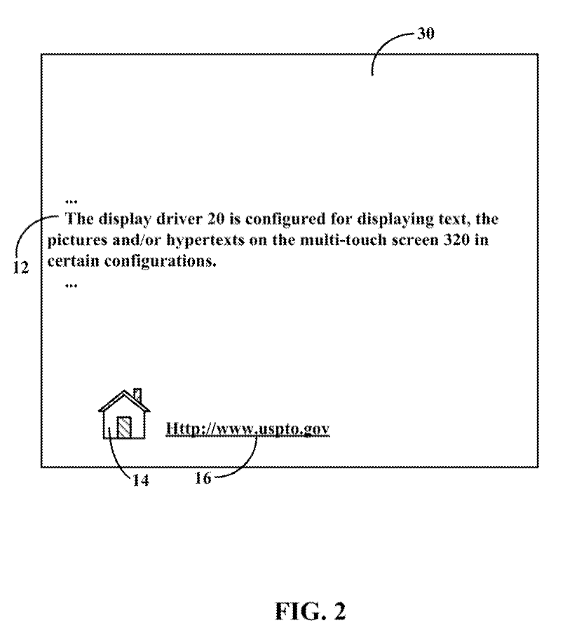

The display driver 20 is configured for displaying text, image and/or hypertext information in the multi-touch screen 30 in certain configurations. Referring to FIG. 2, for example, a paragraph of text 12, an image 14, and a hyperlink 16 (i.e., a line of hypertext) are displayed in the multi-touch screen 30.

The multi-touch screen 30, such as a liquid crystal display (LCD) based multi-touch screen, is configured for receiving user inputs.

The input system 40 is configured for detecting user inputs via the multi-touch screen 30 and interpreting the user inputs as a command. The command is inputted to the display driver 20 and is configured for instructing the display driver 20 to access data corresponding to the command from the storage unit 10 and to display the accessed data in the multi-touch screen 30 as a corresponding menu (see below). In particular, the input system 40 includes a first detecting unit 42, a second detecting unit 44, a reading unit 46, and an inputting unit 48.

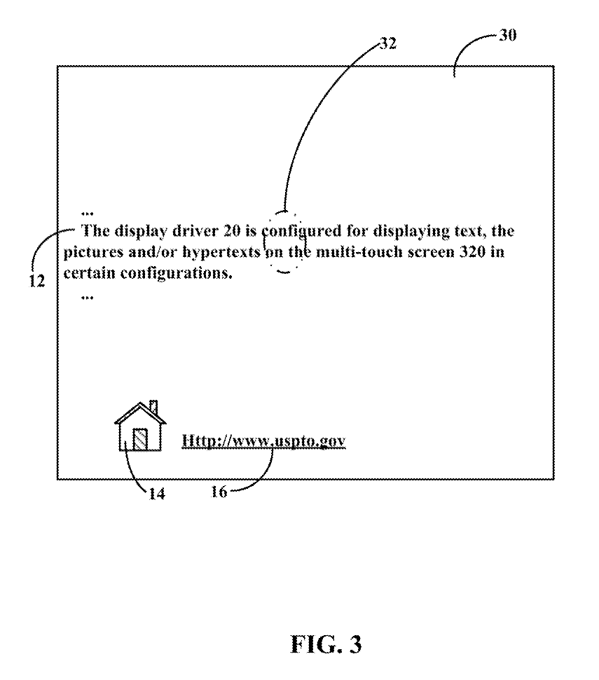

Also referring to FIG. 3, the first detecting unit 42 is configured for detecting a first user input of performing a continuous touch operation on a location 32 of the multi-touch screen 30. Also, the first detecting unit 42 is configured for activating the second detecting unit 44 if the first user input is detected and inactivating the second detecting unit 44 when the first user input is no longer detected.

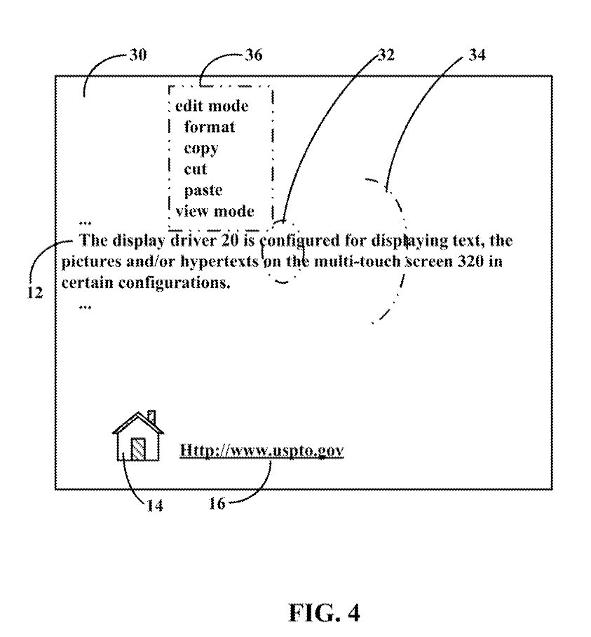

Also referring to FIG. 4, the second detecting unit 44, when activated, is configured for detecting a second user input of performing a slide operation on the multi-touch screen 10 while the first user input is detected (a broken curved line 34 in FIG. 4 represents a track of the slide operation). In addition, the second detecting unit 44 is configured for activating the reading unit 46 if the second user input is detected and inactivating the reading unit 46 when the second input is no longer detected or the second detecting unit 44 is inactivated by the first detecting unit 42. Further, the second detecting unit 44 is configured for signaling the first detecting unit 42 to reset if the second user input is no longer detected.

The reading unit 46, when activated, is configured for reading an attribute of content at the location 32 of the first user input and configured for activating the inputting unit 48. The attribute of the content may be text, image, or hypertext.

The inputting unit 48, when activated, is configured for interpreting the first user input and second user input to a command corresponding to the attribute. For example, as shown in FIG. 4, the attribute is text. Therefore, the detected first user input and the second user input are interpreted as a command for triggering a text options menu 36. Accordingly, after receiving the command, the display driver 20 accesses data corresponding to the command from the storage unit 10 and displays the accessed data in the multi-touch screen 30 as the text options menu 36 in a vicinity of the location 32 of the first user input. The text options menu 36 for operating text may include the following options: edit mode, format, copy, cut, paste, and view mode.

While various exemplary and preferred embodiments have been described, it is to be understood that the invention is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. An input system for use in an electronic device, the electronic device comprising a storage unit, a display driver, and a multi-touch screen, the storage unit being configured for storing data, the display driver being configured for displaying the data in the multi-touch screen in a certain configuration, the multi-touch screen being configured for receiving more than one user input, the input system comprising:
a first detecting unit configured for detecting a first user input of performing a continuous touch operation on a location of the multi-touch screen;
a second detecting unit configured for detecting a second user input of performing a slide operation on the multi-touch screen while the first user input is detected;
a reading unit configured for reading an attribute of content at the location of the first user input if the second user input is detected; and
an inputting unit configured for inputting a command corresponding to the attribute to the display driver, the command being for signaling the display driver to access data corresponding to the signal and display the accessed data on the multi-touch screen as a menu.

2. The input system of claim 1, wherein the first detecting unit is configured for activating the second detecting unit if the first user input is detected and inactivating the second detecting unit if the first user input is no longer detected.

3. The input system of claim 1, wherein the second detecting unit is configured for activating the reading unit if the second user input is detected and inactivating the reading unit if the second user input is no longer detected or the second detecting unit is inactivated by the first detecting unit.

4. The input system of claim 1, wherein the second detecting unit is configured for signaling the first detecting unit to reset when the second user input is no longer detected.

5. The input system of claim 1, wherein the reading unit is configured for activating the inputting unit.

6. The input system of claim 1, wherein the menu is displayed in a vicinity of the location of the first user input.

7. An electronic device comprising:
a storage unit for storing data;
a multi-touch screen for receiving more than one user input;
a display driver for driving the data to be displayed in the multi-touch screen in a certain configuration; and
an input system comprising:
a first detecting unit configured for detecting a first user input of performing a continuous touch operation on a location of the multi-touch screen;
a second detecting unit configured for detecting a second user input of performing a slide operation on the multi-touch screen while the first user input is detected;
a reading unit configured for reading an attribute of content at the location of the first user input if the second user input is detected; and
an inputting unit configured for inputting a command corresponding to the attribute to the display driver, the command being for signaling the display driver to access data corresponding to the signal and display the accessed data on the multi-touch screen.

8. The electronic device of claim 7, wherein the storage unit is a secure digital card.

9. The input system of claim 7, wherein the multi-touch screen is a liquid crystal display based multi-touch screen.

10. The input system of claim 7, wherein the data is selected from the group consisting of text, image, and hypertext information.

11. The electronic device of claim 7, being selected from the group consisting of: a mobile phone, a personal digital assistant, a gaming device, and a laptop computer.
